(19) United States
(12) Patent Application Publication
(10) Pub. No.: US 2022/0280389 A1
(43) Pub. Date: Sep. 8, 2022

(54) Syringe Assembly & Method for Accurate Dosing

(71) Applicant: Control, Ltd., Lebanon, PA (US)

(72) Inventors: Sereyviseth Pheng, Lebanon, PA (US); Sophornarak Horn, Lebanon, PA (US)

(73) Assignee: Control, Ltd., Lebanon, PA (US)

(21) Appl. No.: 17/571,623

(22) Filed: Jan. 10, 2022

Related U.S. Application Data
(60) Provisional application No. 63/157,648, filed on Mar. 6, 2021.

(51) Int. Cl. A61J 7/00

(52) U.S. Cl. CPC A61J 7/0053; A61J 2205/20; G01F 11/027

(57) ABSTRACT

A method and apparatus for controlling and visually, audibly, and tactilely communicating the administration of discrete unit doses of material dispensed from a syringe through use of a modified plunger having a geometric profile corresponding to a unit dose. This profile engages with the syringe barrel in a manner that creates noise and vibration as each unit dose is administered. The profile may take the form of peaks and valleys or teeth. Alternatively, the plunger profile may be threaded and may include a channel along the plunger's longitudinal axis.

### CROSS REFERENCE TO RELATED APPLICATIONS

This application claims benefit of priority from U.S. Provisional Patent Application No. 63/157,648 of Sereyviseth Pheng and Sophornarak Horn, filed Mar. 6, 2020, entitled SYRINGE ASSEMBLY FOR ACCURATE DOSING, the entirety of which is incorporated herein by reference.

### STATEMENT REGARDING FEDERALLY SPONSORED RESEARCH/DEVELOPMENT

Not Applicable

### PARTIES TO A JOINT RESEARCH AGREEMENT

Not Applicable

### REFERENCE TO SEQUENCE LISTING, TABLE OR COMPUTER PROGRAM

Not Applicable

### FIELD OF THE INVENTION

The present invention relates to a method and apparatus for advancing accurate quantities of fluids within a syringe for more controlled administration or dosing. While the device relates more particularly to oral dosing of viscous fluids, the apparatus and method may be used to dispense specific quantities of any liquid within the barrel of a syringe and is suitable for the administration of oral medications as well as those requiring injection into the body.

### BACKGROUND OF THE INVENTION

Syringes are commonly used to inject liquid materials into the tissues of an organism. A standard syringe is comprised of a graduated barrel containing the desired liquid, a plunger adapted to fit within the barrel and advance the liquid, a flange to steady the administrator's thumb against the plunger, a barrel tip, and, optionally, a needle screwed into the barrel tip. When the needle is removed, the syringe may be used to administer oral medications or to direct small quantities of liquid to a desired area. These liquids may be medicinal in nature or may encompass other fluids such as adhesives, cements, epoxies, and the like.

Standard syringes work well for liquids with low viscosities; however, those administering viscid fluids may find it difficult to apply sufficient pressure to advance the material. Patients who are self-administering medications may find accurate dosing a challenge, particularly if their motor skills or eyesight are compromised. This can pose a serious health danger when an exact quantity of medication is required.

Medications often come in varying potencies which may differ greatly depending on the mode of manufacture or other variables. Those suffering from illnesses such as Parkinson's disease, multiple sclerosis, glaucoma, fibromyalgia, as well as chronic inflammation and pain disorders frequently have poor vision as well as diminished hand strength and motor control. Consequently, self-administration of medications through a syringe is often difficult and dangerous when one considers the possibility of accidental overdose.

A number of displacement devices have been designed offering controlled means for dispensing material within a syringe; however many of the designs encase the syringe within complex and costly external fixation devices. Attachment of these devices to the desired syringe requires visual acuity and manual dexterity. While these designs may assist in advancing viscous materials, they offer little in the way of tactile or auditory feedback and fail to address the needs of those with compromised faculties. Furthermore, these known devices typically allow reverse motion of the plunger which may undermine proper administration of the liquid.

Based on the aforementioned shortcomings of existing devices, there is a need in the art for a method and apparatus for administering accurate quantities of medications or other liquids within a syringe in a safe, simple, and effective manner.

### BRIEF SUMMARY OF THE INVENTION

The present invention seeks to provide a device and method for the accurate administration of material within a syringe. Syringes come in a variety of shapes and sizes and are comprised of a barrel, a plunger, and a flange to help stabilize the device when in use.

Typically a desired substance is placed within a syringe barrel and a plunger is positioned behind that material at the proximal end of the barrel. The syringe operator places their index and middle fingers beneath the lower surfaces of the flange, applying pressure to the plunger with their thumb. Dosing in this manner relies heavily on the volumetric markings printed or molded within the barrel and these markings are often difficult to discern. Dosing of medication can become problematic when the material being dispensed is viscous in nature as the user may struggle to apply sufficient force while simultaneously attempting to monitor the liquid exiting the barrel.

The devices and method described herein, offer a substantial improvement over this standard administration practice. The present invention allows the user to focus on accurate dosing and improves safety by offering audio, visual, and tactile cues as each unit dose is dispensed. This is of particular importance when one possessing diminished sensory or motor skills is administering drugs from a syringe. While inventors anticipate that the method and device of the present invention will be used for dispensing medications, one will appreciate that it may also be used for delivering epoxies, adhesives and other viscous materials requiring precise application.

In the present invention, a standard syringe plunger is replaced with a modified plunger having a feature on its geometric profile that corresponds to a desired dose, hereinafter referred to as a “unit dose”. This profile feature, or unit dose geometry, mates with an engagement mechanism within (or attached to) the syringe barrel such that a distinct noise and vibration is generated with each unit dose.

The user of the present invention advances liquid within the syringe by rotating (or alternatively pushing) the end of the plunger. The modified plunger and engagement mechanism work in concert to control the motion and rate of advancement of the plunger, thereby providing more uniform and controlled dispensing of the material within the syringe. Regulation of this motion and advancement can be achieved through the use of threads on both the engagement mechanism and plunger, by corresponding positive and negative contours on these two components, or through a combination of these elements. The threads and/or contours within the plunger profile and engagement mechanism are designed to create audible and tactile feedback to the user as each unit dose is administered.

Contours on the plunger may take the form of cavities, channels, prominences, or protrusions forming a “unit dose geometry”. The engagement mechanism has a corresponding profile that facilitates recurrent engagement with the unit dose geometry as the plunger advances within the syringe barrel, hereinafter, the “receiving element”. The receiving element may take the form of a deformable component such as an elastic tab, spring loaded element, or similar mechanical device as described more fully below.

As the plunger advances within the engagement mechanism, the receiving element yields in a manner that allows it to store mechanical energy. An audible clicking sound and accompanying vibration emanates from the syringe assembly as the unit dose geometry engages with the receiving element. Sound and tactile cues are generated as the potential energy is rapidly converted into noise and motion when the unit dose geometry snaps into the receiving element. The shape or spring loaded nature of the receiving element allows the engagement mechanism to disengage from the unit dose geometry as the plunger end is turned or pushed, causing the plunger to advance the next unit dose.

Graphic positioning aids may be molded into the plunger end to provide additional visual cues to the user to aid in the prevention of over or underdosing. The audio, visual, and tactile feedback provided with the advancement of the plunger allows the user to see, hear, and feel the number of doses that they have administered.

In one embodiment, a threaded plunger having a single channel mates with a spring loaded pin within the engagement mechanism. The combination of these elements controls the rate of advancement of the plunger and prevents reverse motion of this plunger. The syringe emits a noise and vibration as the energy stored within the spring propels the pin into the channel as it rotates in place with each unit dose. This embodiment is ideal for those requiring micro doses of material within the syringe.

In another embodiment, the auditory and tactile cues are provided through a toothed plunger having a series of peaks and valleys. The distance between the valleys on the plunger defines the unit dose and can therefore be designed to suit the potency of the medication being administered. As the user applies pressure to the end of the plunger, the peaks on the profile force the elastic member within the engagement mechanism to deform and store potential energy. This energy is released as a noise and vibration when the elastic member reaches a valley on the plunger profile. An optional dosing key may be affixed to the valleys within the plunger profile to limit the plunger's travel distance within the barrel. Labeled or color coded keys may also be used to track dosing schedules.

### BRIEF DESCRIPTION OF THE DRAWINGS

FIG. 1A is a cross-sectional side view of an embodiment of the syringe assembly wherein the engagement mechanism is located within the barrel

FIG. 1B is an enlarged perspective view of the engagement mechanism within the barrel of the embodiment in FIG. 1A

FIG. 2A is a perspective view of an embodiment of the syringe assembly having a threaded plunger wherein the engagement mechanism is within a clip assembly encasing the barrel

FIG. 2B is a perspective view of an embodiment having a clip assembly, a toothed plunger, and a set of dosage limiting keys

FIG. 3A is a top elevational view of a male clip section having a protective covering

FIG. 3B is a perspective view of a male clip section without the protective covering

FIG. 3C is a side view of the male clip section

FIG. 3D is a cross-sectional view of the male clip section taken a point B-B in FIG. 3C

FIG. 4A is a top elevational view of a female clip section having a protective covering

FIG. 4B is a side view of a female clip section

FIG. 4C is a perspective view of a female clip section without a protective covering

FIG. 4D is a cross-sectional view of the female clip section taken a point B-B in FIG. 4B

FIG. 5A is a side view of one embodiment having a threaded and channeled plunger

FIG. 5B is a detailed view of the threads and channel taken at detail F in FIG. 5A

FIG. 5C is a top view of the administration knob

FIG. 5D is a cross-sectional view of the plunger illustrating the channel or groove in the threads taken at section L-L in FIG. 5B

FIG. 6A is a perspective view of an embodiment of the syringe assembly showing a spring loaded engagement mechanism without a protective covering

FIG. 6B is a detailed view of the plunger threads and channel within the engagement mechanism taken at detail G in FIG. 6A

FIG. 6C is a top view of the engagement mechanism showing the pin and fixed portion of the clip assembly

FIG. 7A is a detailed view of the pin engaged with the root of the plunger thread taken at detail G in FIG. 6A

FIG. 7B is a detailed view of the pin engaged with the plunger channel taken at detail Gin FIG. 6A

FIG. 8A is a side view of an embodiment having a clip assembly, bell-shaped plunger stops, and a plurality of dosage limiting keys

FIG. 8B is a cross-sectional side view taken at section D-D in the embodiment of FIG. 8A

FIG. 8C is a detailed view of the plunger stops within the clip assembly taken at detail E of FIG. 8B illustrating the position of the pin

FIG. 9A is a perspective view of a threadless bell-shaped cavity within the receiving element that may be used in conjunction with the push plunger profile

FIG. 9B is a perspective view of a threadless slotted cavity within the receiving element that may be used in conjunction with the push plunger profile

FIG. 10A is a perspective view of one embodiment of a dosage limiting key that may be removed and reattached while the plunger is inserted into the barrel

FIG. 10B is a perspective view of another embodiment of a dosage limiting key that is slipped onto the plunger before it is inserted into the barrel and having one clamping aperture

FIG. 10C is a perspective view of another embodiment of a dosage limiting key having two clamping apertures

FIG. 11A is a perspective view of an embodiment of the syringe assembly having bell shaped plunger stops and a single dosage limiting key

FIG. 11B is a side elevational view of the embodiment shown in FIG. 11A

FIG. 11C is a cross-sectional view of the embodiment of FIG. 11B taken at section D-D

FIG. 11D is a detailed view of the plunger stops within the barrel as well as the dosage limiting key taken at detail E in FIG. 11C

FIG. 12A is a perspective view of a dosage limiting key inserted onto a toothed plunger and inserted within a standard barrel without an engagement mechanism

FIG. 12B is a perspective view of a dosage limiting key inserted onto a threaded plunger and inserted within a standard barrel

### REFERENCE NUMERAL LISTING

5 Syringe Assembly
10 Modified Plunger
15 Syringe Barrel
18 Engagement Mechanism
20 Clip Assembly
25 Flange
30 Female Clip Section
35 Male Clip Section
40 Deformable Tabs
45 Fastening Means
50 Stops
55 Catch Plates
60 Plunger Threads
65 Slot/Channel/Cavity/Protrusion on Plunger
70 Longitudinal Axis of the Modified Plunger
75 Knob
80 Proximal End of Plunger
85 Plunger Tip
90 Distal (Dispensing) End of Barrel
95 Receiving Element
98 Receiving Element Cavity
100 Pin
105 Spring
108 Spring Cavity
110 Fixed Portion of Clip Assembly
115 Referential Knob Marking
120 Plunger Stop/Tooth/Prominence
125 Valley
130 Dosage Limiting Keys
135 Insertion Aperture
140 Clamping Aperture

### DETAILED DESCRIPTION OF THE INVENTION

Specific terms are used for the sake of clarity in describing the embodiments below. The invention is not intended to be limited to the selected terminology and it should be understood that each specific element includes all technical equivalents operating in a similar manner to accomplish a similar function.

In this patent application, materials dispensed by syringe, including those with extremely high viscosities such as oils, syrups, polymers, adhesives, and similar substances, shall be referred to as a “liquid,” “fluid,” or “material”. For the purposes of this application a “unit dose” shall be defined as the amount of a medication administered to a patient in a single dose. It should be further appreciated that each unit dose may be broken into fractional unit doses by altering the unit dose geometry.

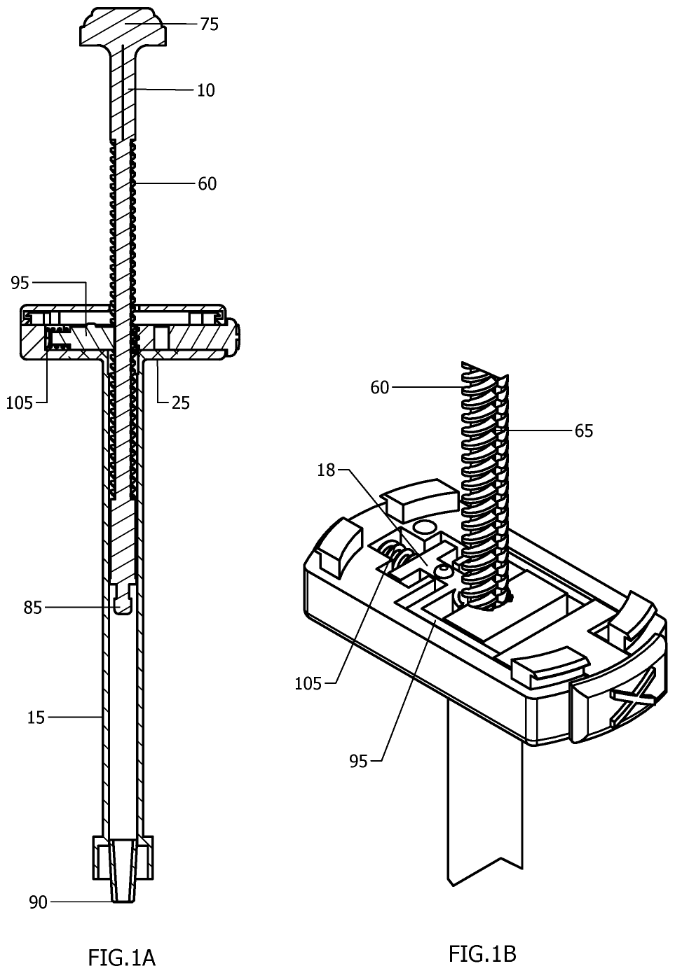

The device and method of the present invention 5 are comprised of a modified plunger 10 placed within the interior of a syringe barrel 15 having an engagement mechanism 18 as shown in FIGS. 1A and 1B. The modified plunger 10 has a profile or unit dose geometry that recurrently mates with and advances within the engagement mechanism 18 such that a distinct sound and vibration is generated with each unit dose (or fractional unit dose) as described more fully below.

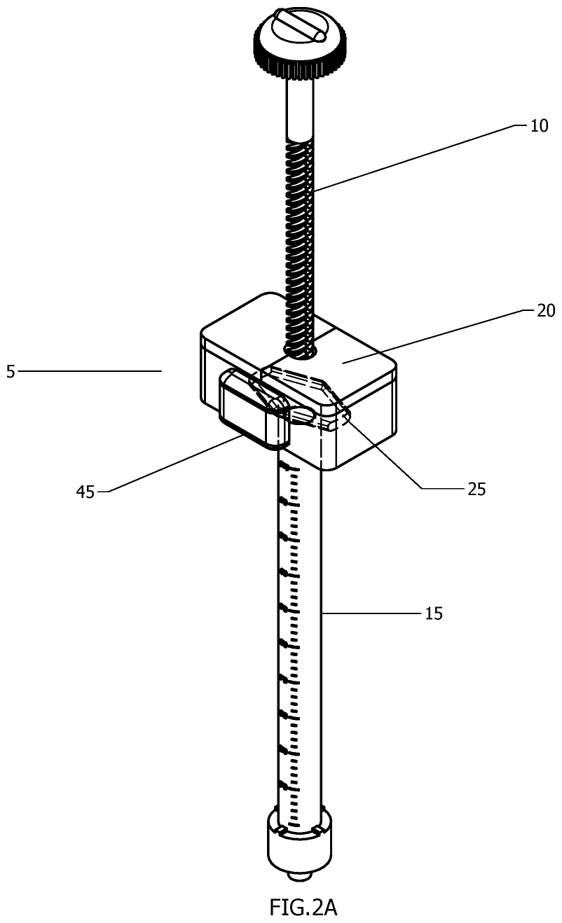

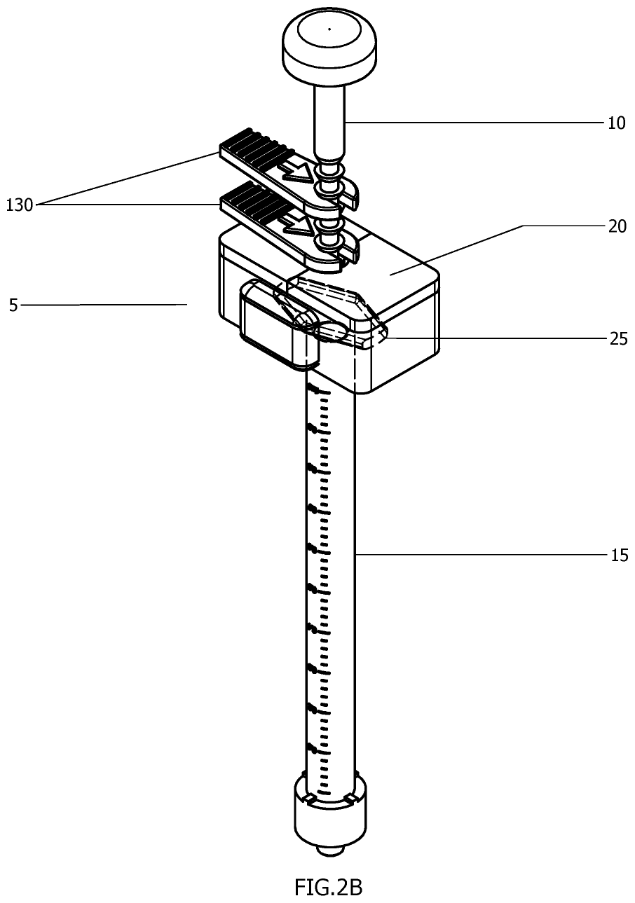

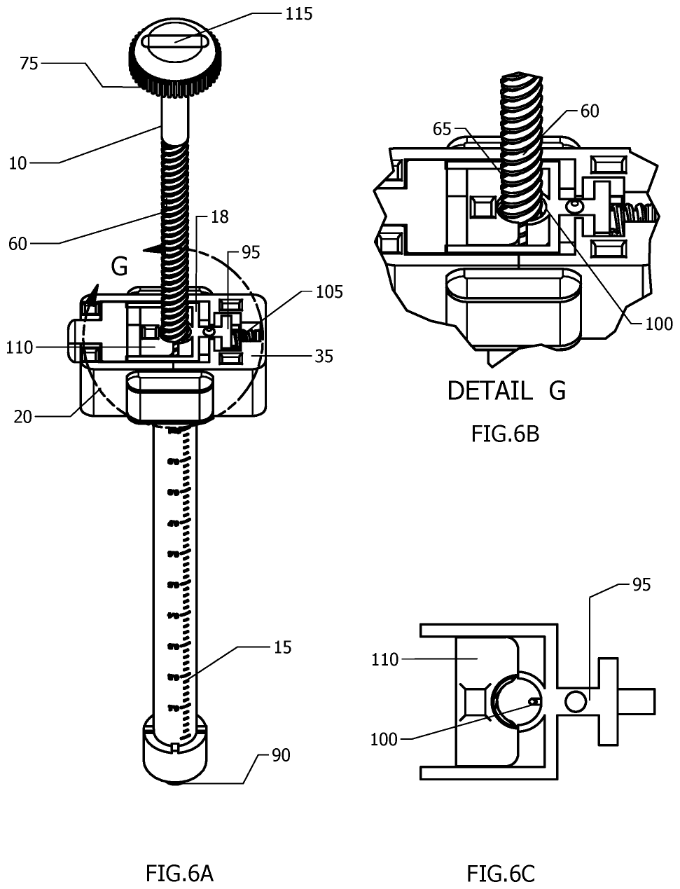

The engagement mechanism 18 may alternatively be housed within a clip assembly 20 that encases the flange 25 as shown in FIGS. 2A, 2B, and 6A. The addition of the clip assembly 20 eliminates the need to form or secure the engagement mechanism 18 within the syringe barrel 15, allowing the apparatus to be easily attached as an after-market device to a wide range of pre-existing syringe barrel makes and models.

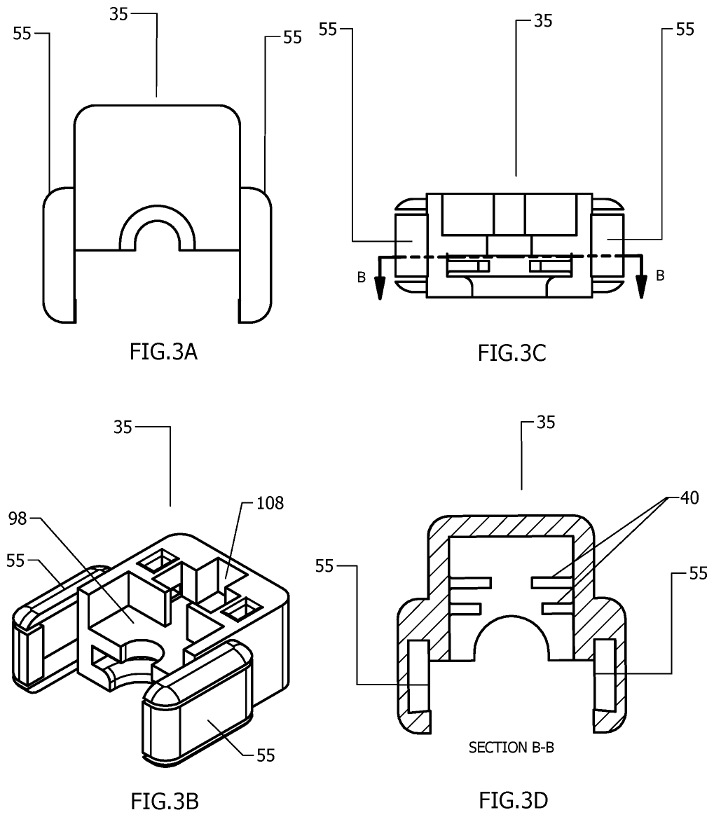

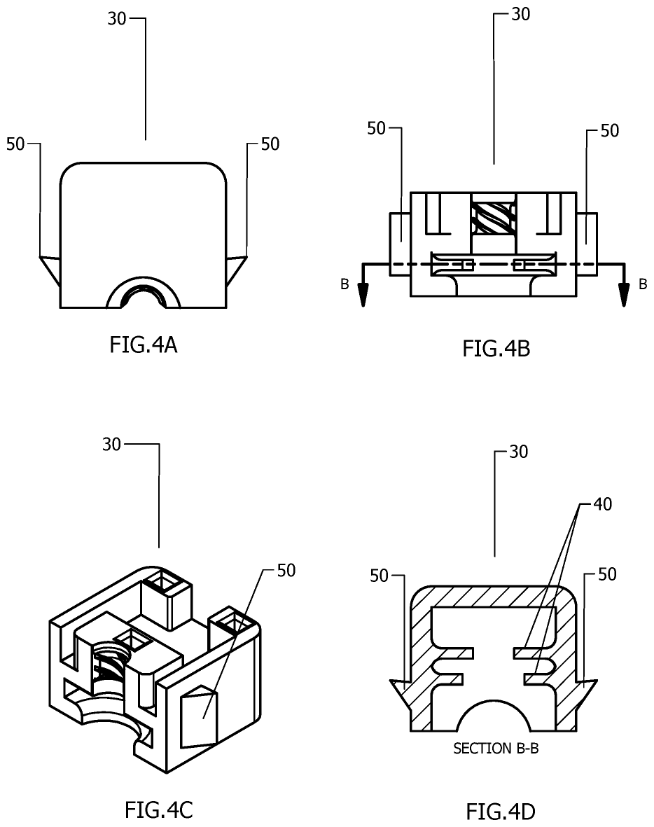

One embodiment of the clip assembly 20 comprises a female clip section 30 and a male clip section 35 as depicted in FIGS. 3A and 4A and illustrated in greater detail in FIGS. 3B-3D and 4B-4D. Referring now to FIGS. 3D and 4D, a set of deformable tabs 40 within each section of the clip assembly 20 bend and/or detach, thereby wedging the flange 25 within the clip assembly 20 as illustrated in FIGS. 2A and 2B. An internal or external fastening means 45 or mechanism may additionally connect the female clip section 30 to the male clip section 35 of the clip assembly 20 such that it is secured about the flange 25 as illustrated in FIG. 2A. Referring now to FIGS. 4A-4D, one embodiment features a set of wedge shaped stops 50 on the female clip section 30 that engage and lock within corresponding catch plates 55 on the male clip section 35 shown in FIGS. 3A-3D, thereby securing the clip assembly 20 about the syringe flange 25. It should be understood that the clip assembly 20 may be comprised of more than two sections and that such sections may be secured about or directly to the syringe flange 25. It should further be recognized that any number of fastening means, adhesives, coupling geometries, or plastic welding or fusing techniques may be used to secure the clip assembly 20 about or to said flange 25.

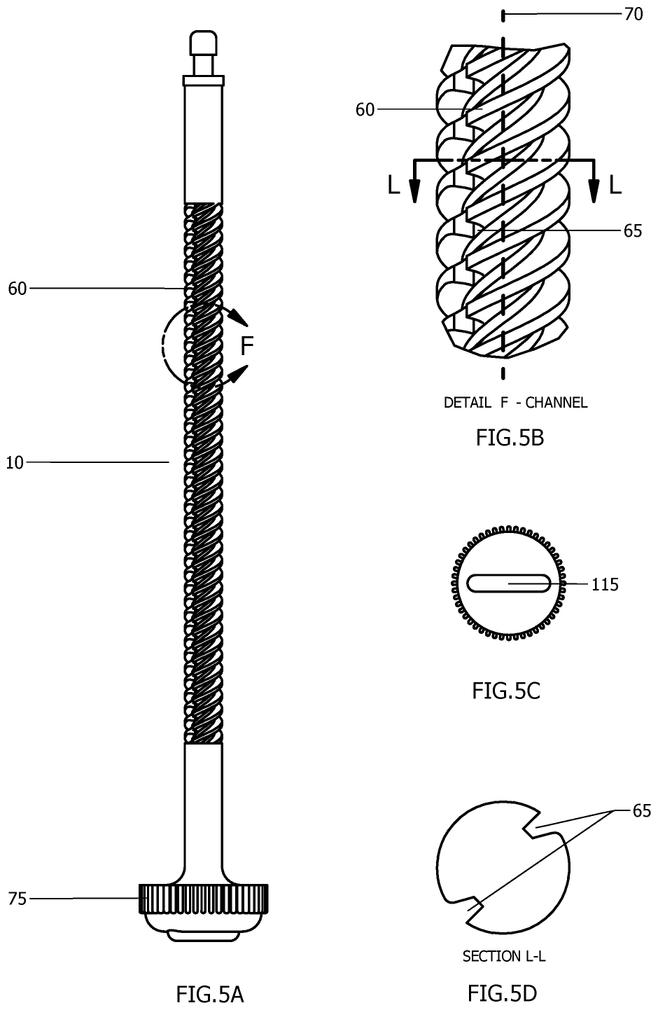

As previously noted, one objective of the present invention is to provide a method and mechanism to deliver repeatable quantities of liquid from the syringe barrel 15. In one embodiment, the geometric profile of the modified plunger 10 includes threads 60 and additionally includes at least one slot or channel 65 along the length of the longitudinal axis 70 of the plunger 10 as shown in FIGS. 5A and 5B. The plunger 10 may be equipped with a knob 75 at the proximal end of the plunger 80 which may be knurled to improve grip on the unit 5. This knob 75 may additionally include a printed or molded visual indicator such the referential mark 115 shown in FIG. 5C to monitor the rotational position of the plunger.

In the embodiment depicted in FIG. 6A, liquid within the barrel 15 advances through the syringe assembly 5 by rotating the knob 75. This motion is transferred to the plunger 10 affixed to the knob 75 causing it to rotate within the engagement mechanism 18 and advance within the length of the syringe barrel 15 as depicted more clearly in FIG. 1A. As the plunger 10 progresses, uniform force is transferred from the plunger tip 85 to the liquid within the barrel 15, causing this material to exit the distal end 90 of the syringe assembly 5.

While the present invention aims to provide a simple and controlled means to administer liquid within the barrel 15, it also seeks to provide a sensory experience with each unit that is delivered. These additional features improve safety by offering multiple cues to the user as each dose is dispensed. This is accomplished through intermittently complimentary profile geometries designed to build potential energy within either the receiving element 95 or the unit dose geometry of the plunger 10.

In one embodiment, a spring loaded receiving element 95 within the engagement mechanism 18 is fitted with a pin 100 that engages with the threads 60 and channel(s) 65 on the plunger 10 as shown in FIG. 6B. The spring 105 sits within the spring cavity 108 depicted in FIG. 3B. The receiving element 95 sits within the receiving element cavity 98 as depicted in FIG. 3B. While it should be appreciated that the engagement between the pin 100 and plunger 10 may be achieved in multiple ways, FIG. 6A depicts one embodiment wherein spring 105 applies force to the receiving element 95, pushing the pin 100 into the root of the plunger threads 60 and wedging said plunger 10 against a fixed portion 110 within the clip assembly 20. Both the fixed portion 110 and the receiving element 95 have a geometry that accommodates the curvature and diameter of the plunger 10 as shown in FIGS. 6A-6C.

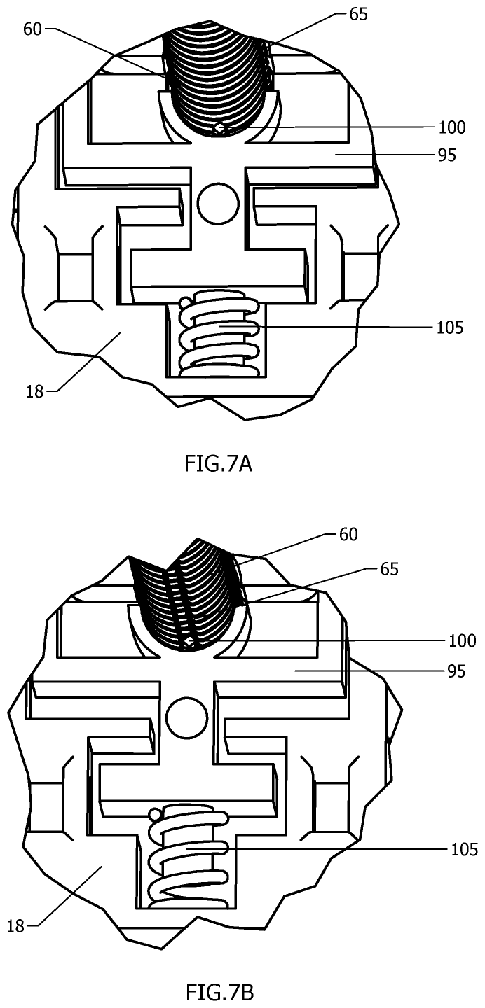

As the knob 75 is rotated, pin 100 engages with and follows the contours of the root of the plunger threads 60, compressing spring 105 and thereby increasing the potential energy within the receiving element 95. When the pin 100 reaches the channel 65, spring 105 rapidly propels the receiving element 95 into the cavity, creating a sound and vibration. See FIGS. 7A and 7B. As the user continues to apply torque to the knob 75, the pin 100 moves out of the channel and into the threads once again. This movement is assisted by the cross-sectional-geometry of the plunger 10 shown in FIG. 5D. Once the pin 100 has left the channel 65, the spring 105 compresses allowing receiving element 95 to retract slightly. See FIGS. 7A and 7B. The curved entry to the channel 65, as illustrated in FIG. 5C, allows the pin 100 to move up and out of the channel 65 and back into the root of the plunger threads 60 where the process repeats, periodically “clicking” as it interlocks with each channel 65.

This audible “click” is accompanied by a tactile sensation as the pin 100 engages with each channel 65 on the threaded plunger 10. The knob 75 may additionally be fitted with a molded image such as the referential knob marking 115 shown in FIGS. 5C and 6A. Such a marking provides the user with another visual and tactile point of reference and offers an added means of tracking material as it is dispensed.

A single longitudinal slot or channel 65 within the threaded plunger 10 corresponds to a desired unit dose. Additional slots or channels 65 may be added if fractional unit doses are desired. In other words, the number of degrees of rotation between each channel 65 corresponds to a volume of fluid dispensed from the syringe assembly 5. The channels 65 must be equidistant about the circumference of the plunger 10 to ensure equal dosing; however, the plunger 10 can conceivably include as many longitudinal channels 65 as the circumference of that plunger 10 will accommodate. The spacing of the channels 65 may therefore be customized depending on the size of the syringe being used as well as the potency of the material being administered.

The present invention is designed such that the plunger 10 will advance toward the distal (dispensing) end of the barrel 90. The profile geometry may include additional features that prevent the retraction or reverse rotation of the plunger 10. In the embodiment described above, the geometry of the pin 100 engagement with the plunger threads 60 coupled with the force exerted on the plunger 10 as it is wedged between the spring loaded receiving element 95 and the fixed portion 110 of the clip assembly 20, prevents the user from retracting or unscrewing the plunger 10 from the barrel 15. This allows the user to keep track of the doses administered and protects against inadvertent contamination of the liquid within the barrel. Inventors anticipate the addition of a recessed button, pin hole, or similar retraction mechanism to disengage the receiving element 95 from the plunger 10, such that the plunger 10 may be withdrawn from the barrel 15 if needed.

In another embodiment the modified plunger 10 profile allows for more swift administration of liquid within the barrel 15 by offering a set of tactile and auditory plunger stops or teeth 120 for each unit dose. This embodiment is preferable for those requiring rapid, multiple unit doses. Each plunger stop 120 is comprised of a profile geometry that engages with the receiving element 95. A pin 100 similar to that described in the first embodiment, moves over the profile peaks of the plunger 10 and then clicks within each valley 125. Force to the plunger 10 is transferred to the receiving element 95, causing the spring 105 to compress and allowing the pin 100 to follow the contour of the stop or tooth 120 until it is propelled into next valley 125, creating the noise and vibration to signal the administration of a unit dose.

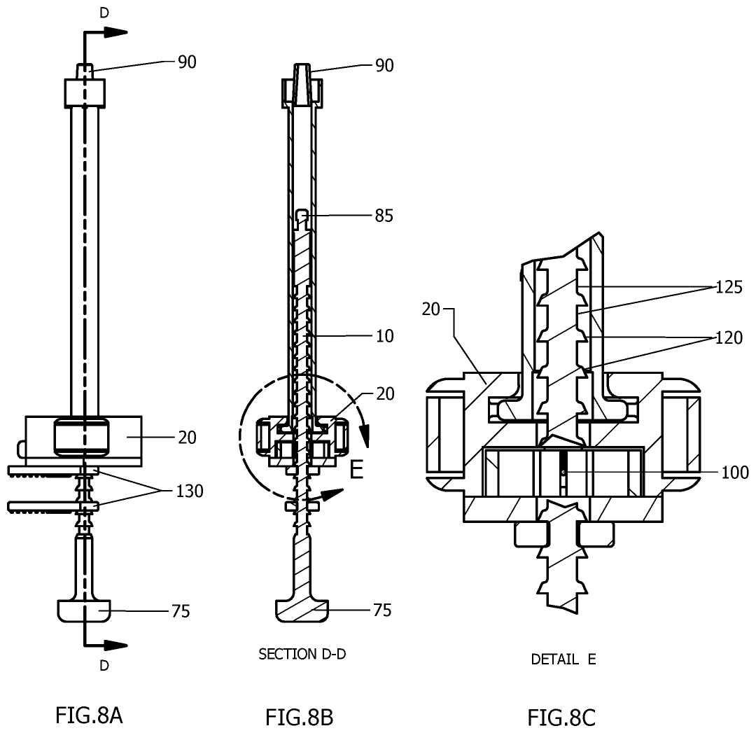

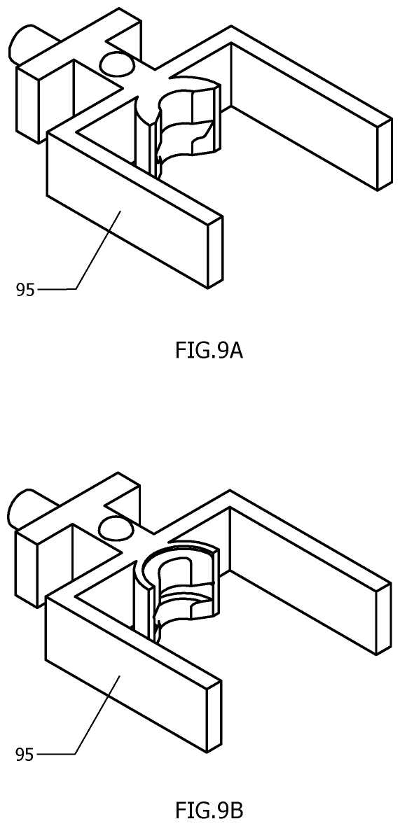

FIGS. 8A and 8B, illustrate one example of this embodiment wherein bell shaped “teeth” are used. The pin 100 emits a noise and sensation as it moves from the tooth 120 and “clicks” into the adjacent valley 125 on the plunger 10. The profile of the plunger stops or teeth 120 may take any number of forms provided that the pin 100 emits an audible and tactile signal to the user when it returns to each valley 125 in that profile.

Each “unit dose” is determined by the distance between the valleys 125 in the profile. Plunger profiles will vary and may be customized depending on the potency of the material being administered and the size of the barrel and corresponding plunger. The desired unit dose is determined based on the volume of material to be administered and the required length of travel of the plunger required to achieve this volume. The length of travel will depend upon the size of the barrel and plunger to be used. A discrete series of prominences and cavities or channels are designed such that the distance between each set of peaks and each set of cavities is equivalent to the distance of plunger travel required to administer a unit dose. This “unit dose geometry” is incorporated along or within the longitudinal axis of the plunger as described above. The distance between the valleys 125 or channel 65 in the unit dose geometry will be shorter for more potent medications and longer for medications having reduced potency.

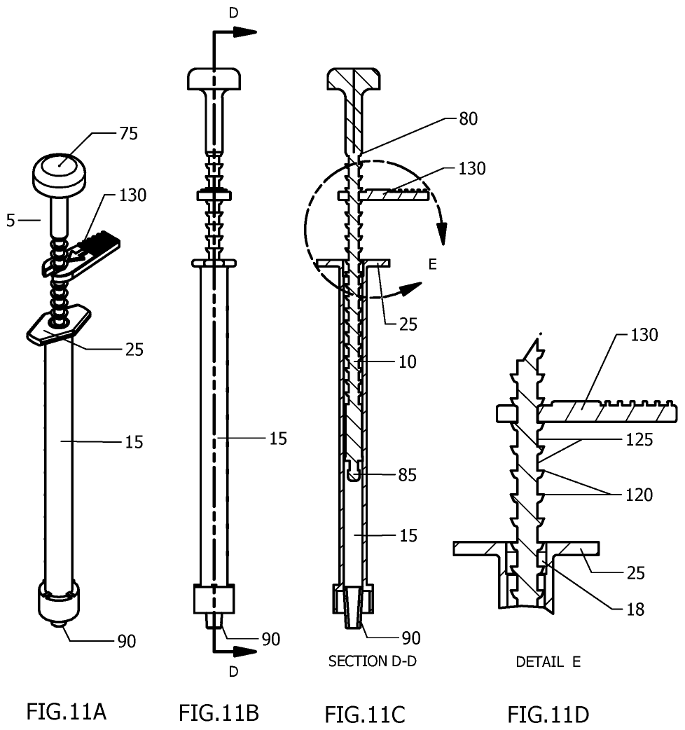

It should be appreciated that any number of profiles may be used to achieve the communication of unit dose such as the bell-shaped stops 120 and valleys 125 and slotted cavities depicted in FIGS. 11A and 11B. These profiles may be used with or without threads. This combination allows the user to push the plunger 10 for more rapid dosing and to turn it if micro-dosing is required. It should also be understood that the receiving element may be elastic in nature and may take the form of a deformable spring tab, eliminating the need for a separate spring. It should be further appreciated that the plunger 10 may include an elastic element or protrusion that recurrently snaps into corresponding complimentary geometry within the engagement mechanism 18.

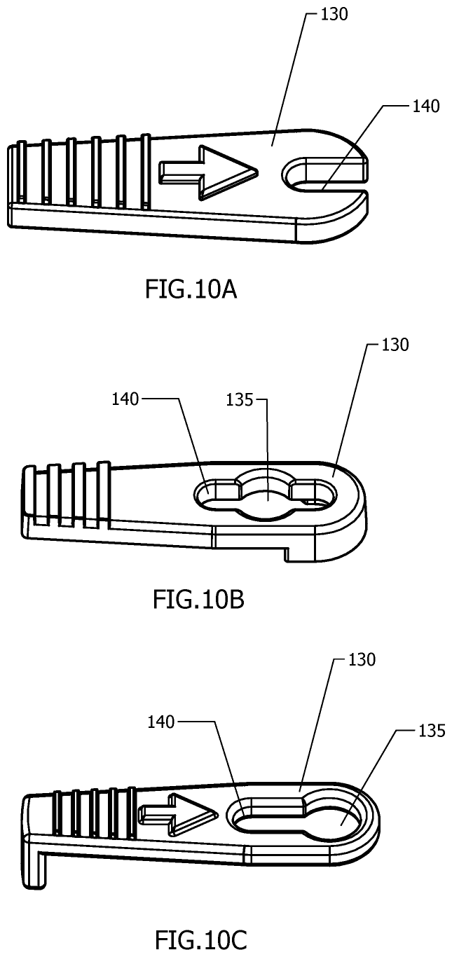

Referring now to FIGS. 10A-C and 11A, one or more dosage limiting keys 130 may be used in conjunction with the rapid dosing plunger 10 to improve the safety of administration. Use of multiple dosage limiting keys 130 may also help in tracking daily dosing as depicted in FIG. 2B. These keys 130 may be labeled with specific hours or days or may be color coded or labeled to suit the needs of the user. Labeling may be printed or molded into the keys to provide additional tactile feedback for those with reduced visual acuity. To use the key 130, the person administering the material counts the number of unit doses corresponding to the number of teeth 120 on the plunger profile through visualization or alternatively by touch. The key 130 is then placed in the desired valley 125 above the desired number of teeth 120. When ready, the user applies pressure to the end of the plunger 10. The motion of the plunger 10 is impeded when the key 130 makes contact with flange 25 (as shown in FIG. 11B) or clip assembly 20 (as shown in FIG. 2B). The key 130 operates as a physical limiter, signaling to the user that the required quantity of material has been administered.

FIGS. 11B-11D shows that the engagement mechanism 18 may be placed directly within the barrel 15 as opposed to the clip assembly 20. In this configuration an elastic member such as a flexible tab, ring or similar mechanism be molded or fixed within the barrel such that the plunger profile provides the audible and tactile feedback as the unit moves past the engagement mechanism 18. One should appreciate that the profile of the plunger 10 may alternatively be elastic in nature and may engage with a more rigid engagement mechanism 18 within the barrel 15 to create these cues.

In another embodiment, a plunger 10 having a unit dose geometry that allows for the attachment of one or more dosage limiting keys 130 is inserted into a barrel 15. As noted above, the user counts the number of plunger stops or teeth 120 corresponding to the desired dose via visual or tactile means and places a dosage limiting key 130 within the applicable dosing valley 125 according to their needs. The plunger 10 is depressed until the dosage limiting key 130 makes contact with the flange 25. Additional dosage limiting keys 130 with molded or printed symbols or color coding may additionally be placed on the plunger 10 to track dosing schedules and quantities. These dosage limiting key(s) 130 may be used on a modified plunger 10 having plunger stops 120 within a standard barrel 15 or they may be used in combination with a barrel 15 having an internal or external engagement mechanism 18, such as the clip assembly 20, described above.

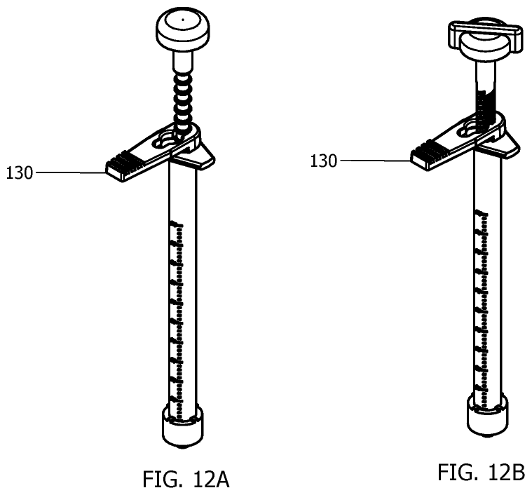

FIG. 12A illustrates a second embodiment of a dosage limiting key 130 used within a modified plunger 10 having a series of peaks and valleys. This key 130 has an insertion aperture 135 that allows the key 130 to slip over the modified plunger 10 before it is inserted into a standard barrel 15. This design prevents the key 130 from falling off the unit 5. As previously noted, the distance between valleys in the unit dose geometry is equivalent to a single unit dose. The user selects the number of unit doses to be dispensed by the syringe assembly 5 by counting a corresponding number of valleys above the flange 25. The dosage limiting key is manipulated such that one of the clamping apertures 140 seats firmly within the selected valley. The user administers liquid by depressing the plunger 10; however, the plunger travel will be restricted once the dosage limiting key 130 contacts the flange 25.

The dosage limiting key may also be used in threaded unit dose geometries as shown in FIG. 12B. Here a unit dose is defined by the pitch of the threads as described above. The user selects the number of unit doses to be dispensed by counting a corresponding number of thread valleys above the flange. The dosage limiting key is manipulated such that one of the clamping apertures 140 seats firmly within the selected valley 125. The user administers liquid by rotating the plunger 10 but again, the plunger 10 travel will be restricted once the dosage limiting key 130 makes contact with the flange 25. Since a unit dose is determined by the thread pitch, the user may be able to select a half unit dose by moving the opposing clamping aperture 140 to the opposite side of the unit dose geometry.

Inventors anticipate that the components described herein will be manufactured from durable autoclavable plastics such as polypropylene and polyethylene; however it should be recognized that any suitable material may be used.

While the above description contains many specifics, these should be considered exemplifications of one or more embodiments rather than limitations on the scope of the invention. As previously discussed, many variations are possible and the scope of the invention should not be restricted by the examples illustrated herein.

1. An apparatus for controlling and visually, audibly, and tactilely communicating the administration of discrete unit doses of material dispensed from a syringe, the apparatus comprising:
a barrel having an interior and adapted to contain a liquid within said interior of the barrel, the barrel comprising a distal end, a proximal end, and an engagement element; and
a plunger having an exterior and a longitudinal axis, said plunger configured to be inserted into the proximal end of the barrel and being moveable within the interior of said barrel such that liquid within the barrel is advanced and delivered from the distal end of the barrel when force is applied to the plunger, said plunger exterior comprising a unit dose geometry along the longitudinal axis of said plunger corresponding to a plurality of unit doses of material, wherein said engagement element recurrently engages and disengages with the unit dose geometry as the plunger advances within the barrel, said recurrent engagement creating visual, audible and tactile feedback with each administered unit dose.

2. The apparatus of claim 1 wherein the engagement element is comprised of a deformable receiving mechanism and a projecting element, and wherein the unit dose geometry is comprised of a series of uniformly spaced peaks and valleys such that the spacing between each peak and valley corresponds to a desired unit dose of liquid, and wherein the projecting element recurrently engages and disengages with the peaks and valleys of the unit dose geometry as the plunger is advanced within the barrel, said recurrent engagement creating visual, audible and tactile feedback with each administered unit dose.

3. The apparatus of claim 1 wherein the engagement element is comprised of a deformable receiving mechanism and a projecting element, and wherein the unit dose geometry is comprised of at least one channel along the longitudinal axis of the plunger and a series of uniformly spaced threads about the plunger exterior such that the pitch of the threads corresponds to a desired unit dose of liquid, and wherein the projecting element recurrently engages and disengages with each channel as the plunger is advanced within the barrel, said recurrent engagement creating visual, audible and tactile feedback with each administered unit dose.

4. The apparatus of claim 1 wherein the plunger has an outer circumference and wherein multiple channels are introduced along the longitudinal axis of the plunger and are spaced equidistantly about said outer circumference to provide visual, audible and tactile feedback for fractional unit doses.

5. The apparatus of claim 1 wherein the engagement mechanism is molded within the interior of the barrel.

6. The apparatus of claim 1 wherein the engagement mechanism comprises a release mechanism that allows the plunger to be withdrawn from the barrel.

7. The apparatus of claim 1 wherein the plunger comprises a knurled knob.

8. The apparatus of claim 1 wherein the plunger comprises a knob with a visual indicator.

9. The apparatus of claim 1 further comprising at least one dosing key, the at least one dosing key being removeably attached to the unit dose geometry such that the motion of the plunger is restricted when said dosing key contacts the proximal end of the barrel.

10. The apparatus of claim 1 further comprising at least one color-coded dosing key, the at least one color-coded dosing key being removeably attached to the unit dose geometry such that the motion of the plunger is restricted when said dosing key contacts the proximal end of the barrel.

11. The apparatus of claim 1 further comprising at least one labeled dosing key, the at least one labeled dosing key being removeably attached to the unit dose geometry such that the motion of the plunger is restricted when said dosing key contacts the proximal end of the barrel.

12. An apparatus for controlling and visually and tactilely communicating the administration of discrete unit doses and fractional unit doses of material dispensed from a syringe, the apparatus comprising:
a barrel having an interior and adapted to contain a liquid within said interior of the barrel, the barrel comprising a distal end, a proximal end, and a flange;
a plunger having an exterior and longitudinal axis, said plunger configured to be inserted into the proximal end of the barrel and being moveable within the interior of said barrel such that liquid within the barrel is advanced and delivered from the distal end of the barrel when force is applied to the plunger, said plunger exterior comprising a unit dose geometry along the longitudinal axis of said plunger corresponding to a plurality of unit doses and fractional unit doses of material; and
a dosage limiting key wherein said dosage limiting key is placed at a desired point along the unit dose geometry to deliver a selected unit dose or fractional unit dose of liquid and wherein said dosage limiting key stops the advancement of the plunger when it contacts the flange, thereby preventing further delivery of liquid from the barrel and providing visual and tactile feedback with each administered unit dose or fractional unit dose of liquid.

13. An apparatus for controlling and visually, audibly, and tactilely communicating the quantity of material dispensed from a syringe, the apparatus comprising:
a barrel comprising an interior and a flange and adapted to contain a liquid within said interior of the barrel, the barrel further comprising a distal end, a proximal end, and an engagement element secured about said flange;
a plunger configured to be inserted into the proximal end of the barrel, said plunger being moveable within the interior of said barrel such that liquid within the barrel is advanced and delivered from the distal end of said barrel when force is applied to the plunger, said plunger comprising a unit dose geometry, wherein said unit dose geometry comprises a geometric profile corresponding to a desired unit dose of material to be administered and wherein said unit dose geometry recurrently engages and disengages with the barrel engagement element as the plunger advances within the barrel, said recurrent engagement creating visual, audible and tactile feedback with each administered unit dose.

14. The apparatus of claim 13 wherein the engagement element is comprised of at least two mating sections and wherein said at least two mating sections comprise a set of deformable tabs that wedge said flange within the at least two mating sections.

15. The apparatus of claim 13 wherein the engagement element is comprised of at least two mating sections and wherein the at least two mating sections are mechanically fastened to one another about the flange.

16. The apparatus of claim 13 wherein the engagement element is comprised of at least two mating sections and wherein the at least two mating sections are adhered to one another about the flange.

17. The apparatus of claim 13 wherein the engagement element is comprised of at least two mating sections and wherein the at least two mating sections are fused to one another about the flange.

18. A method for controlling and visually, audibly, and tactilely communicating a quantity of
material dispensed from a syringe, the method comprising the steps of:
(a) Selecting a desired unit dose of liquid to be dispensed by a syringe;
(b) Selecting a plunger comprising a longitudinal axis and an exterior;
(c) Selecting a barrel comprising an interior;
(d) Calculating the required length of travel of the plunger within the selected barrel to deliver the desired unit dose of liquid;
(e) Creating a series of discrete unit dose prominences wherein the distance between each adjacent prominences corresponds to the required length of travel of the plunger for each unit dose;
(f) Incorporating said unit dose prominences along or about the longitudinal axis of the plunger exterior;
(g) Creating an engagement element for recurrently engaging and disengaging with the unit dose prominences on the plunger;
(h) Incorporating said engagement element about the barrel or within the barrel interior;
(i) Introducing a desired liquid into the barrel interior;
(j) Inserting a plunger into the proximal end of the barrel;
(k) Advancing the plunger within the barrel such that the series of unit dose prominences recurrently engage and disengage with the engagement element thereby generating audible, visual and tactile cues.

19. The apparatus of claim 18 wherein the series of unit dose prominences is comprised of a series of peaks and valleys.

20. The apparatus of claim 18 wherein the series of unit dose prominences is comprised of a series of uniformly spaced threads and wherein a channel bisects said threads along the longitudinal axis of said plunger.
